(19) United States
(12) Patent Application Publication
(10) Pub. No.: US 2019/0073180 A1
(43) Pub. Date: Mar. 7, 2019

(54) MIRRORING MOBILE DEVICE DISPLAY ON OTHER MOBILE DEVICE DISPLAY

(71) Applicant: Michael Nunan, Minneapolis, MN (US)

(72) Inventor: Michael Nunan, Minneapolis, MN (US)

(21) Appl. No.: 15/809,430

(22) Filed: Nov. 10, 2017

Related U.S. Application Data
(63) Continuation of application No. 15/695,596, filed on Sep. 5, 2017, now abandoned.

(51) Int. Cl. G06F 3/14; H04L 29/08; H04N 21/4363; H04N 21/41

(52) U.S. Cl. CPC G06F 3/1454; H04L 67/1095; H04L 65/4092; H04N 21/4126; H04N 21/43637

(57) ABSTRACT

A mobile device having a central processing unit, a memory accessible by the processing unit, and a graphical user interface comprising a touch sensitive display screen with a graphical user input for controlling the computer device. A communication module for communicating over WiFi connection and a short-range wireless connection to communicate data between the mobile device and a second mobile device. A mirroring display program is stored in said memory, which when active provides for mirroring the currently displayed screen content on the graphical user interface to the second mobile device. The mirroring display program allows for selecting users from a displayed contact list of users currently online, corresponding to at least the second user device, and able to receive a mirrored displayed screen, and then broadcasting the mirrored display to the selected users.

### CROSS-REFERENCE TO RELATED APPLICATION(S)

Not applicable

### BACKGROUND OF THE INVENTION

### 1. Field of Invention

The present invention relates to mobile communication and transmitting data between mobile devices, more particularly to mirroring the display on one mobile device with another mobile device.

### 2. Description of Related Art

Smart phones and other like mobile devices have increasingly become a stable of social interaction among many social groups. Youtube.com and similar social media websites deliberately market and make available media content that lends itself to sharing among friends and acquaintances. Indeed, the intersection of technical developments in smart phones and social media websites has created a symbiotic relationship as advances in one drive evolution of the other. The ability to record and transmit mixed media content, as well as receive and play mixed media, on smart phones has in-turn led to receptive social media sites evolving to cater to these technical advances.

With the ability to create, download, and upload media data between mobile devices and social media Internet websites, many users desire increased flexibility to share and view this media content on their mobile devices. In particular, considerable numbers of consumers would like to mirror their mobile device display of mixed media on other device displays in close social settings, such as in a bar, club, or restaurant. Such mixed media content may include recorded, downloaded, or live streamed data.

Based on the foregoing, there is a need for improved flexibility to mirror the display of one mobile device on another device in close proximity, such as in a club, bar, restaurant, party site, or other social setting.

### SUMMARY OF THE INVENTION

In an embodiment, there is a mobile device, comprising a central processing unit, a memory accessible by the processing unit, and a graphical user interface comprising a touch sensitive display screen with a graphical user input for controlling the computer device. There is also a communication module for communicating over at least one of a WiFi connection and a short-range wireless connection to communicate data between the mobile device and a second mobile device. A mirroring display program stored in said memory, that when active, provides for mirroring the currently displayed screen content on the graphical user interface to the second mobile device. The mirroring display program allows for selecting users from a displayed contact list of users currently online, corresponding to at least the second user device, and able to receive a mirrored displayed screen, and then broadcasting the mirrored display to the selected users.

The mirror program includes allowing the accepting of mirrored displayed screen from current contacts online.

The mirror program can mirror multiple types of multi-media content.

The multi-media content includes multiple ones of games, movies, TV shows, photos, website content, live video streaming from the smart phone, multi-media data files, documents, or other types of files currently displayed on the graphical user interface.

The mirror program includes a broadcast screen for setting broadcast parameters.

The broadcast parameters comprises at least one of orientation and quality.

The computer device comprises a tablet or a smart phone.

The mirror program allows for editing and adding to the contact user.

The mobile device further comprises further comprises transmitting the mirroring display program from a non-transitory memory.

A method of mirroring a display screen of a mobile device comprising providing a central processing unit, a memory accessible by the processing unit, and a graphical user interface comprising a touch sensitive display screen with a graphical user input for controlling the computer device. Communicating over a WiFi connection to communicate data between the mobile device and a second mobile device. A mirroring display program is stored in said memory. The mirroring display program, when active, provides for mirroring the currently displayed screen content on the graphical user interface to the second mobile device, and the mirroring display program allows for selecting users from a displayed contact list of users currently online, corresponding to at least the second user device, and able to receive a mirrored displayed screen, and then broadcasting the mirrored display to the selected users.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is an exemplary schematic block diagram of the functional components of a mobile device according to an embodiment of the present invention;

FIG. 2 is a an exemplary embodiment of an implementation of the invention using a WiFi access point according to an embodiment of the present invention; and

FIG. 3A-J shows exemplary screen views for executing the software application of the invention according to an embodiment of the present invention.

### DETAILED DESCRIPTION OF PREFERRED EMBODIMENTS

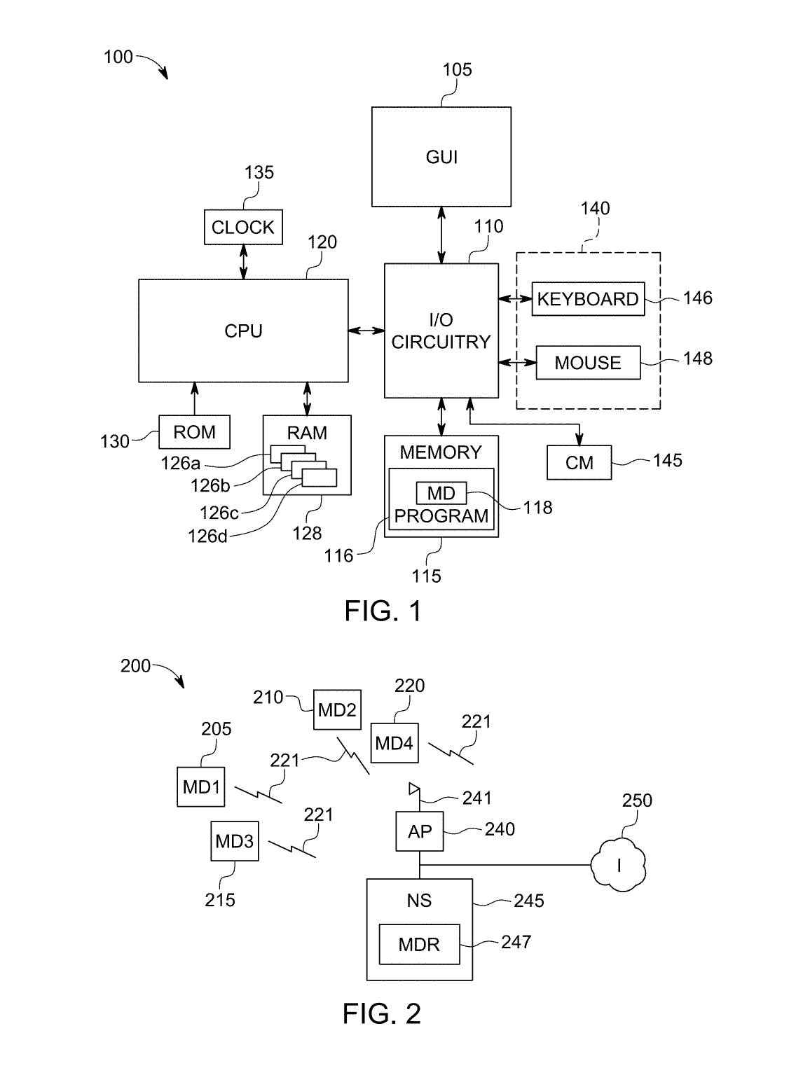

Preferred embodiments of the present invention and their advantages may be understood by referring to FIGS. 1-3A-J, wherein like reference numerals refer to like elements.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

The computer memories in the various disclosed devices may store computer executable instructions. Each disclosed computer/communication device such as computer, a server, a system node, a smart phone, a tablet, or similar device able to execute computer code and/or process digital, electronic data may execute computer executable instructions. The computer executable instructions may be included in computer code. The computer code may be stored in the various device memories. The computer code may be written in any computer language comprising the prior art. The memory may be a non-transitory tangible storage media. Sophisticated computer apps have increasingly become available, with downloaded executable software code (e.g., the Apple® Store) providing for configuring a mobile device, such as a smart phone or tablet, to perform a plethora of functions.

The computer code may be logic encoded in one or more tangible media or one or more non-transitory tangible media for execution by the processor in the devices. Logic encoded in one or more tangible media for execution may be defined as instructions that are executable by the processor and that are provided on the computer-readable storage media, memories, or a combination thereof. Logic may include a software controlled microprocessor, an application specific integrated circuit (ASIC), an analog circuit, a digital circuit, a programmed logic device, a memory device containing instructions, and the like. The instructions may be stored on any computer readable medium comprising the prior art from which a computer, a processor, or other electronic device can read. This may include a computer data disk or the like storing computer code that can be used to configure a memory associated with a computer, a processor, or other electronic device.

The processor may include a general processor, digital signal processor, ASIC, field programmable gate array, analog circuit, digital circuit, central processing unit (CPU), micro-processor unit (MPU), micro-controller unit (MCU), combinations thereof, or other now known processor. The processor may be a single device or combinations of devices, such as associated with a network or distributed processing. The processor may be responsive to or operable to execute instructions stored as part of software, hardware, integrated circuits, firmware, micro-code or the like. The functions, acts, methods or tasks illustrated in the figures or described herein may be performed by the processor executing instructions stored in the memory.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

The present invention will now be described in detail with reference to embodiments thereof as illustrated in the accompanying drawings.

As depicted in FIG. 1, a schematic block diagram 100 shows the internal components of a mobile device 100, such as a computer tablet, smart phone, or the like that can comprise a display 105 comprising a touch sensitive screen functioning as a graphical user interface (GUI), input/output (I/O) circuity 110 for processing and routing input and output data, memory 115 storing digital data, which can include computer programs (in the form of executable program code) 116, including the mirroring display program (MD) 118 of the invention, a central processing unit (CPU) 120, with associated Random Access Memory (RAM) 125 consisting of RAM modules 126a, 126b, 127c, and 126d, Read Only Memory (ROM) 130, a clock 135 regulating the function of the mobile device, and external hardwire 140 that may be attached in the case of a tablet, such as a keyboard 146 or a mouse 148, which also can serve as a user interface. However, typically touch inputs on the touch sensitive display 105, which may also include virtual graphical analogues of the mouse 148 and keyboard 146, provide a user interface for inputs to the device 100. Finally, the mobile device 100 can include a communication module (CM) 145 for accessing the internet and transmitting or receiving data between the mobile device 100 and external data sources, such as a computer server hosting an internet accessible website. CM 145 can facilitate data communication using a cellular communication network, a wifi access point, a Bluetooth® connection, or other localized wireless communication protocol.

In operation, the CPU 120 can access through I/O circuitry 110 memory 115 storing programs 116 and the display mirroring program 118 of the invention. The CPU 120 can execute the programs 116 as well as processing any stored digital data in memory 115. The CPU 120 can also operate to process data received or transmitted via communication module 145 using I/O circuitry 110. The CPU 120 can process received data from or transmitted to communication module 145 as well as data manipulation inputs from the display/input screen 105 of the tablet or exterior hardware 140. The touch sensitive screen forming display/input screen 105 can receive data inputs corresponding to movements of a user's finger, which the CPU 120, utilizing executed programs from memory 115, uses to process data including transmitted and received data from communication module 145.

As depicted in FIG. 2, a WiFi communication network 200, according to an embodiment of the invention, can accommodate a mobile device 205 mirroring its display screen on one or more other nearby mobile devices. Mobile device 1 (MD1) 205 can have a wireless signal 221 in communication with access point (AP) 240 via antenna 241 connected to AP 240. Mobile device 2 (MD2) 210, mobile device 3 (MD3) 215, and mobile device 4 (MD4) 230 likewise can be in communication with AP 240 via antenna 241 using WiFi wireless signals 221. A user of MD1 can mirror the data on the display of MD1 205 using mirroring display program 118.

AP 240 can include an associated node server 245 that comprises a computer and can facilitate communication between AP 240 and the Internet 250 as well as registered mobile devices MD1 205, MD2 210, MD3 215, and MD4 220 over WiFi wireless signals 221. Node server (NS) 245 supports all wireless communication in WiFi network 200. Node server 245 can include a mobile device registry (MDR) 247 comprising a data base on the node server 245 MD containing mobile device identifying information on all mobile devices registered and using WiFi network 200.

In an embodiment, a user of MD1 205 operating the mirroring program 118 can access the information on MDR 247 and identify those mobile devices to mirror the display of MD1 205. For example, the MDR 247 can contain identifiers for all mobile devices registered on WiFi network 200, and the MD1 205 executing MD program 118 can access this information show on display 105. Using this information, a user can select mobile devices on the WiFi network 200 to minor the display of MD1 205.

In an embodiment, a user of MD1 205 can access a list of contacts by name corresponding to stored mobile device identifying information kept in the memory 115 of MD1 205. These contacts can further be associated with identifying icons likewise stored in an associated format in memory 115. A presence program feature active on MD1 205, either independent of MD program 118 or as a programmed portion of MD program 118, can interface with NS 245 to identify the mobile devices associated with the contact list currently on WiFi network 200. These contacts can then be viewed on display 105 and selected, so that display 105 can be mirrored on selected contacts' mobile devices (e.g., MD2 210, MD3 215, and/or MD4 220) that are registered on WiFi network 200.

In an embodiment, a user can interface directly with one or more mobile devices using a short range wireless signal such as a Bluetooth® signal. Using a communication interfacing program, the user can establish a Bluetooth® connection using communication module 145 and then use MD program 118 to minor the display. Alternatively, MD program 118 can include an independent communication software module able to interface with communication hardware and establish the Bluetooth® connection or other wireless connection.

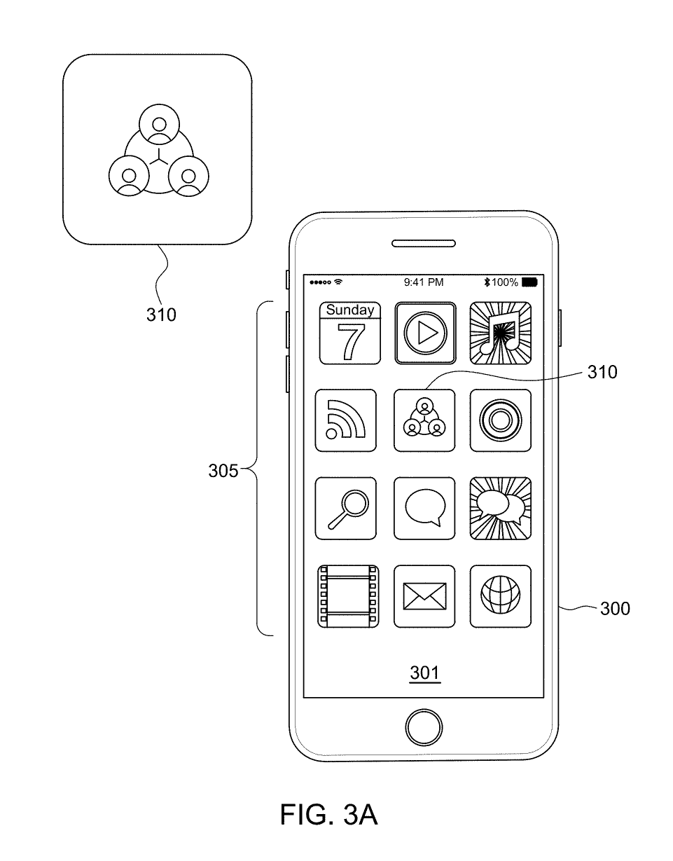

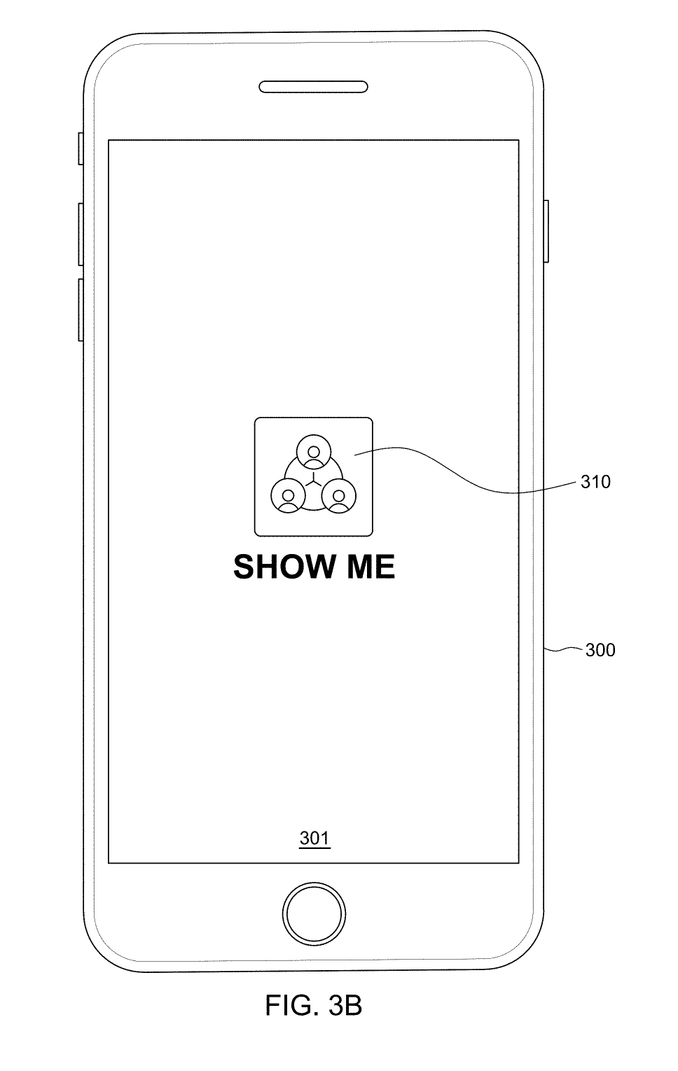

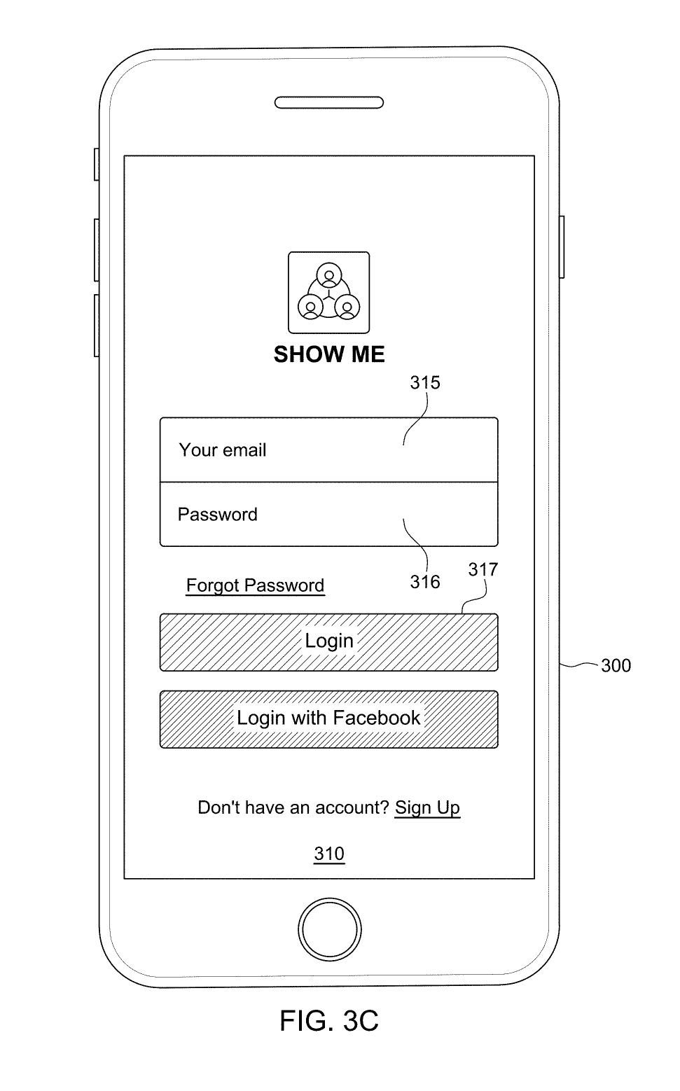

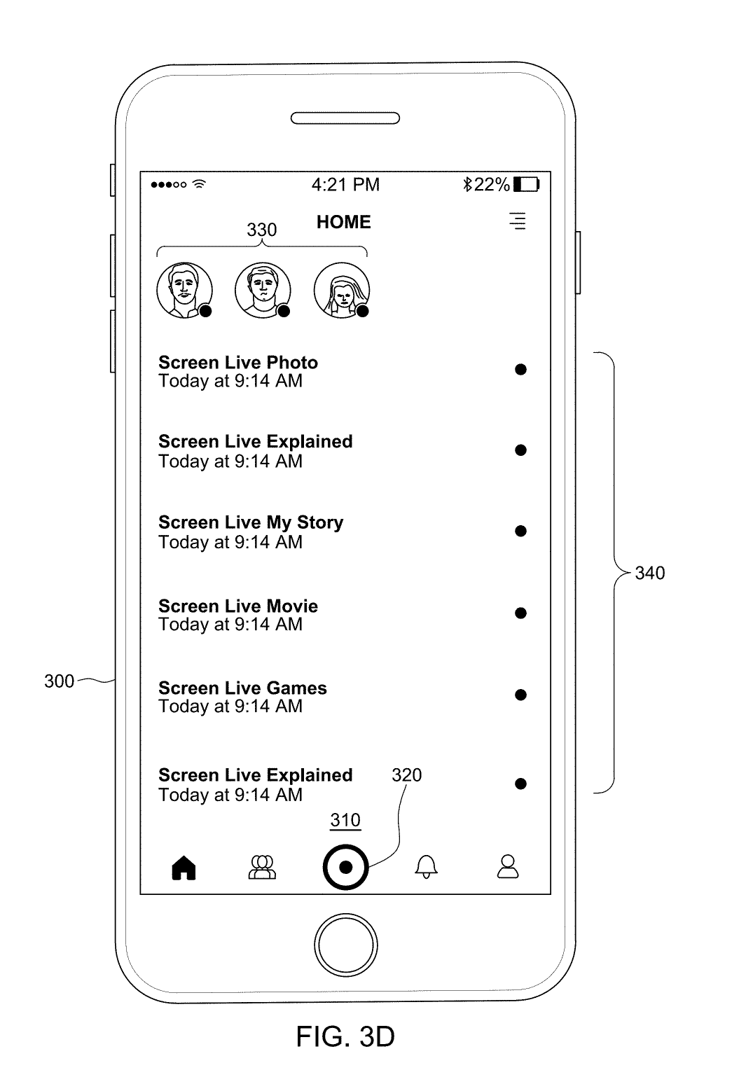

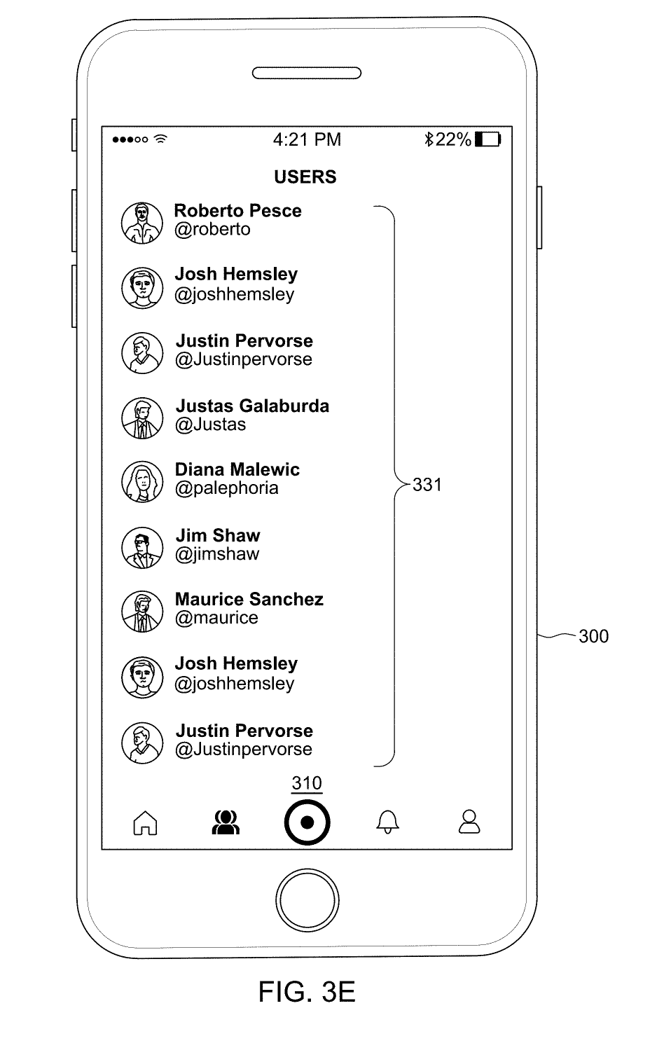

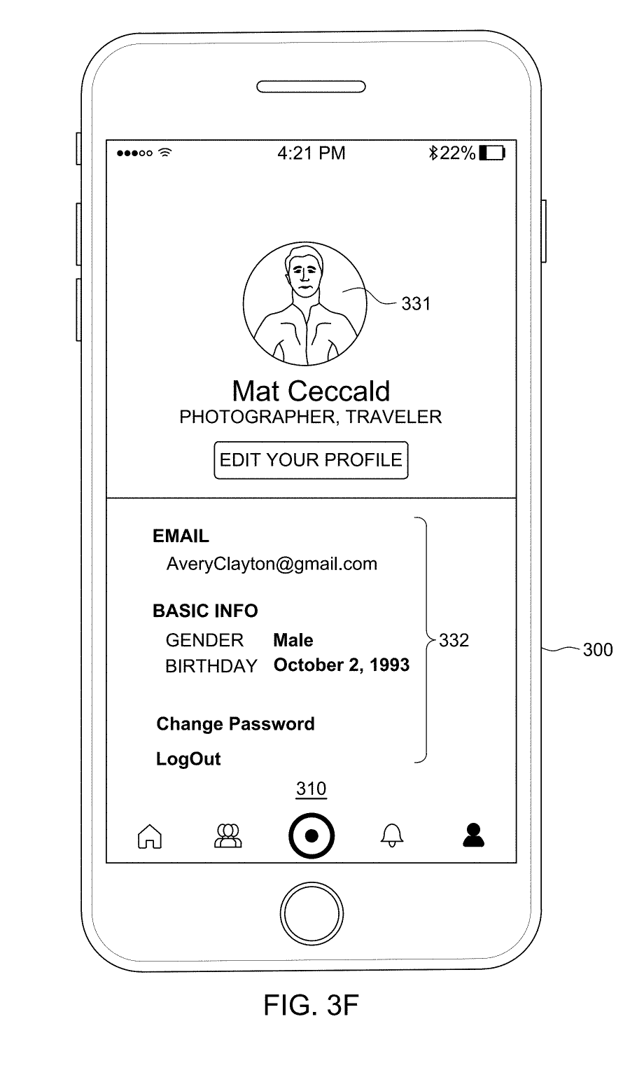

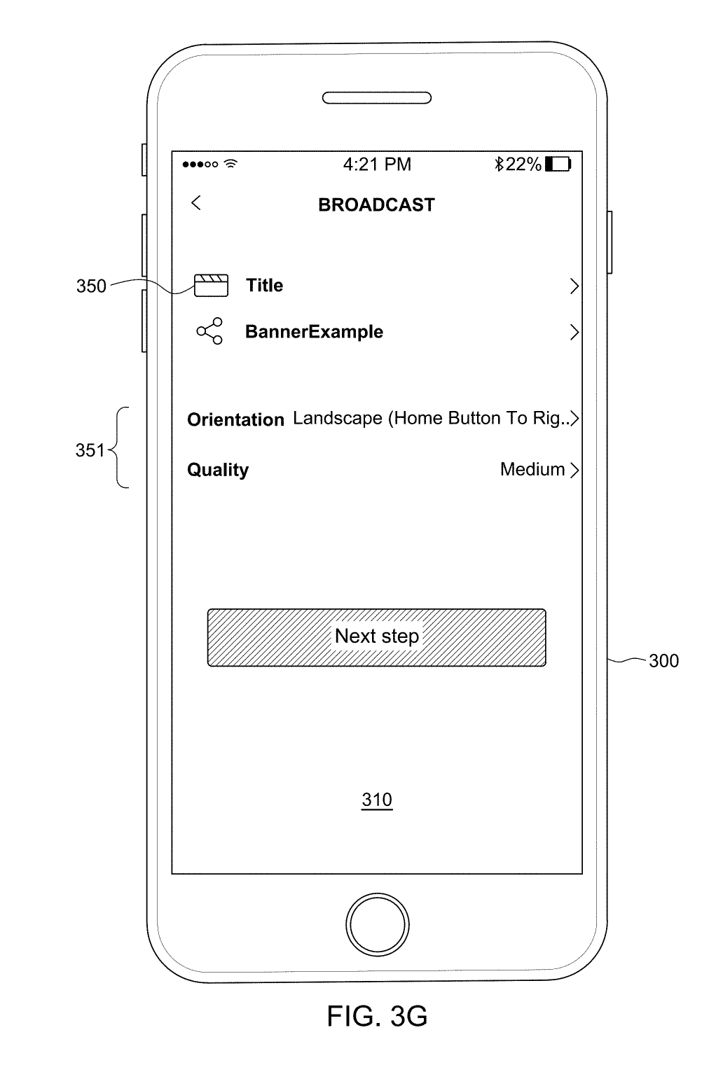

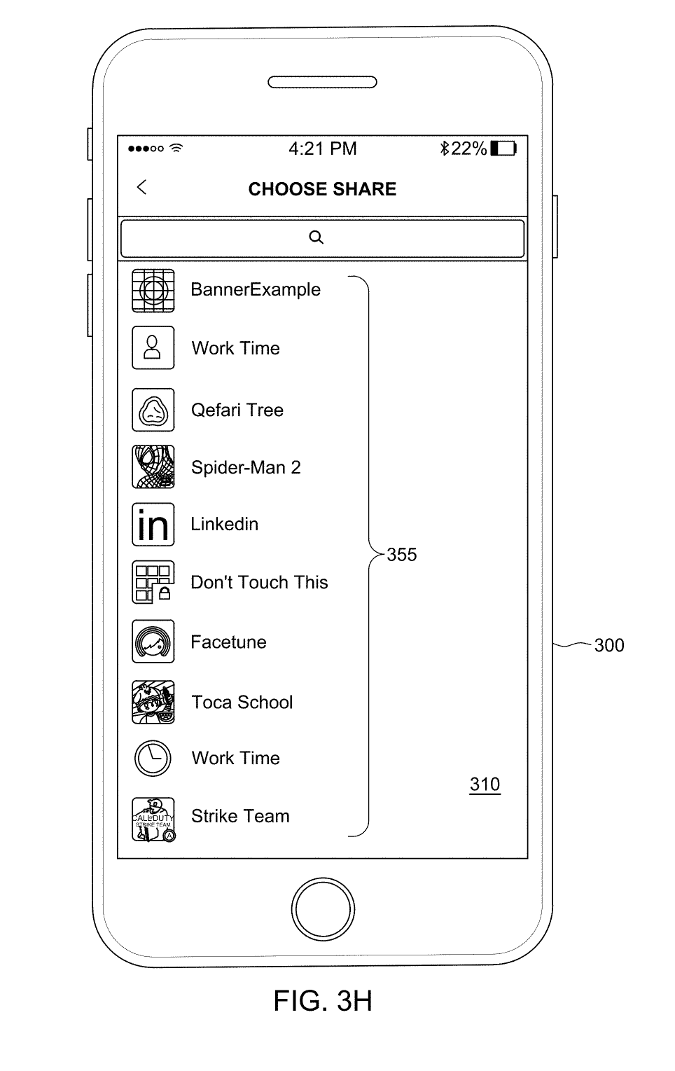

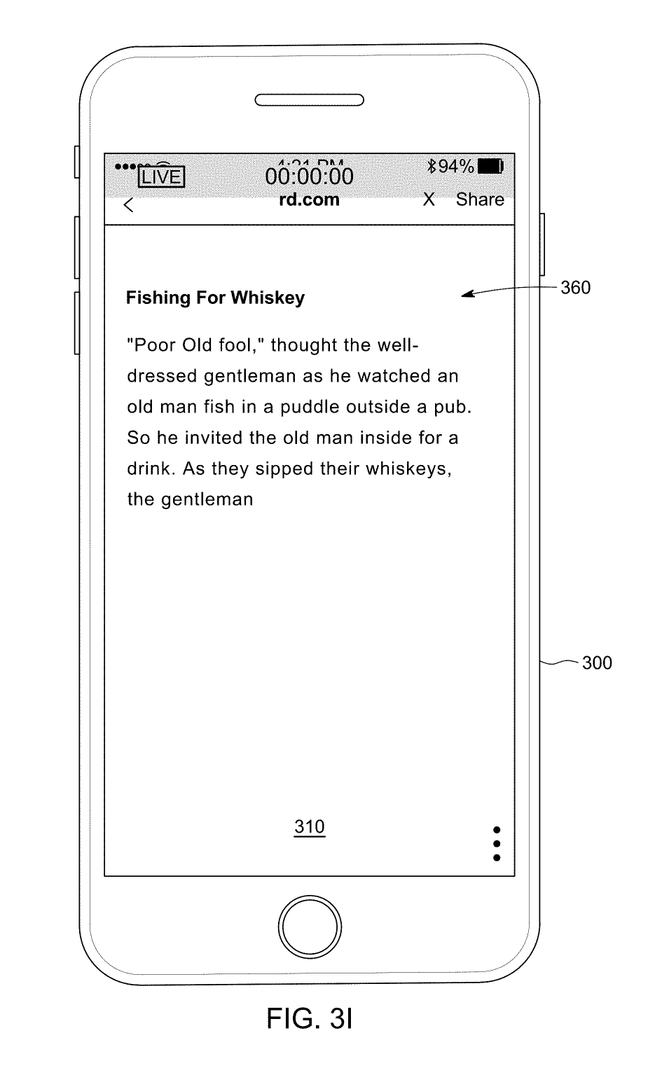

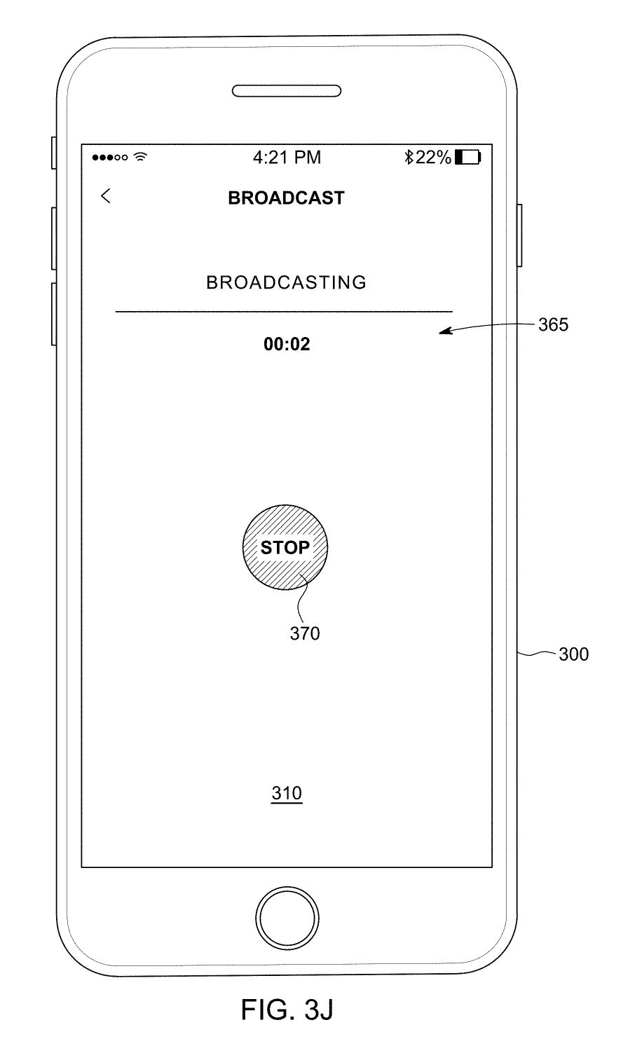

FIG. 3A-J depicts an embodiment of a mobile device 300 executing the software application computer code of the invention in an embodiment. FIG. 3A depicts mobile device 300, such as a smart phone, with a GUI 301 displaying multiple functional icons 305, each of which can be used to open and execute individual applications stored in memory and which mobile device 300 can be configured to use. Each such application can be pre-loaded in the mobile device at the time of sale, or the application computer code can be transmitted by a vendor (e.g., the Apple Store®, Amazon®, etc.) to the smart device 300 and used to configure the mobile device, stored in a memory, or both. Function/app icon 310 can be used as the functional icon for the invention in an embodiment, opening and executing MD 118.

As depicted in FIG. 3B, mobile device 300 shows an activated app splash screen on GUI 301. A splash screen is a graphical control element consisting of a display containing an image comprising a logo/icon and the current version of the software. A splash screen usually appears while a game or program is launching. In this case, the splash screen on GUI 301 can feature the mirroring app icon 305 for MD 118. The term may also be used to describe an introduction page on a website (often referred to as a splash page).

FIG. 3C depicts a login screen on mobile device 300 according to an embodiment of the invention. Login screen as shown on GUI 310 can include an email or screen name 315 and a password 316 entry screen. Once the name 315 and password 316 are entered, login icon 317 can be clicked to continue executing MD 118 (i.e., app 118/305).

As depicted in FIG. 3D, a home screen displayed on GUI 310 on mobile device 300 can include a virtual transmit button 320 to start playing/broadcasting/transmitting and can select media content 340 on mobile device 300. Users as shown by user icons 330 can be transmitting using the same app program MD 118 from their own mobile device, and by clicking on the corresponding user icon 330 the mobile device 300 can receive and display live streaming from the selected user's mobile device. Media content 340 can be selected on GUI 310 to display and can include multiple different media content 340.

As depicted in FIG. 3E, an online user screen displayed on GUI 310 can show saved users, or contacts, icons 331 currently on line and able to receive live streaming using MD 118.

As depicted in FIG. 3F, an online user information screen on GUI 310 can display a saved user icon or picture 331 together with name and user information 332, which can be updated on the screen. The users stored and listed can be referred to as contacts able to receive a mirrored screen. New contacts can be added for mirroring displays using the user information screen.

As depicted in FIG. 3G, a broadcast screen on GUI 310 can display and/or set a broadcast title 350, and can set broadcast parameters 351 such as orientation and quality. Setting broadcast title 350 can include a naming option for naming a current mirroring session by a user of mobile device 300.

As depicted in FIG. 3H, a select app to broadcast screen on GUI 310 can list available applications 355 that can be mirrored, or broadcast, using MD 118. Applications 355 in the exemplary embodiment can include games, movies, TV shows, and other types of multi-media, and for example, can include BannerExample, a first Work Time, Oefari Tree, Spider-Man 2, Linkedin, Don't Touch This, Facetune, Toca School, a second Work Time, and Strike Team. Other options for mirroring can include photos, website content, live video streaming from the smart phone, multi-media data files, documents, or any other types of file currently displayed on GUI 310.

As depicted in FIG. 3I a live screen broadcast screen on GUI 310 can display the current live screen 360 of the GUI 310 being currently mirrored, or broadcasted, using MD 118.

As depicted in FIG. 3J, a broadcast screen on GUI 310 can provide a broadcasting status 365 and includes a stop icon 370 that can be used to stop mirroring. Broadcast screen can also provide a back option to return to the mirrored screen content.

The invention has been described herein using specific embodiments for the purpose of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A mobile device, comprising:
a central processing unit, a memory accessible by the processing unit, and a graphical user interface comprising a touch sensitive display screen with a graphical user input for controlling the computer device;
a communication module for communicating over at least one of a WiFi connection and a short-range wireless connection to communicate data between the mobile device and a second mobile device;
a mirroring display program stored in said memory;
wherein the mirroring display program, when active, provides for mirroring the currently displayed screen content on the graphical user interface to the second mobile device; and
wherein the mirroring display program allows for selecting users from a displayed contact list of users currently online, corresponding to at least the second user device, and able to receive a mirrored displayed screen, and then broadcasting the mirrored display to the selected users.

2. The mobile device of claim 1, wherein the mirror program includes allowing the accepting of mirrored displayed screen from current contacts online.

3. The mobile device of claim 1, wherein the mirror program can mirror multiple types of multi-media content.

4. The mobile device of claim 3, wherein the multi-media content includes multiple ones of games, movies, TV shows, photos, website content, live video streaming from the smart phone, multi-media data files, documents, or other types of files currently displayed on the graphical user interface.

5. The mobile device of claim 1, wherein the mirror program includes a broadcast screen for setting broadcast parameters.

6. The mobile device of claim 5, wherein the broadcast parameters comprises at least one of orientation and quality.

7. The mobile device of claim 1, wherein the computer device comprises a tablet or a smart phone.

8. The mobile device of claim 1, wherein the mirror program allows for editing and adding to the contact user.

9. The mobile device of claim 1, further comprises transmitting the mirroring display program from a non-transitory memory.

10. A method of mirroring a display screen of a mobile device, comprising:
providing a central processing unit, a memory accessible by the processing unit, and a graphical user interface comprising a touch sensitive display screen with a graphical user input for controlling the computer device;
storing a mirroring display program in said memory;
communicating over a WiFi connection to communicate data between the mobile device and a second mobile device;
wherein the mirroring display program, when active, provides for mirroring the currently displayed screen content on the graphical user interface to the second mobile device; and
wherein the mirroring display program allows for selecting users from a displayed contact list of users currently online, corresponding to at least the second user device, and able to receive a mirrored displayed screen, and then broadcasting the mirrored display to the selected users.
